(19) United States
(12) Patent Application Publication
(10) Pub. No.: US 2013/0293426 A1
(43) Pub. Date: Nov. 7, 2013

(54) ELECTRONIC DEVICE

(71) Applicants: Kuo-Chiang Hung, Taipei City (TW); Chieh-Tsao Hwang, Taipei City (TW); Shih-Chia Liu, Taipei City (TW); Chang-Chih Chen, Taipei City (TW); Chen-Ta Hung, Taipei City (TW)

(72) Inventors: Kuo-Chiang Hung, Taipei City (TW); Chieh-Tsao Hwang, Taipei City (TW); Shih-Chia Liu, Taipei City (TW); Chang-Chih Chen, Taipei City (TW); Chen-Ta Hung, Taipei City (TW)

(21) Appl. No.: 13/670,479

(22) Filed: Nov. 7, 2012

Related U.S. Application Data
(60) Provisional application No. 61/643,369, filed on May 7, 2012.

(51) Int. Cl. H01Q 1/52; H01Q 1/22

(52) U.S. Cl. CPC H01Q 1/521; H01Q 1/22
USPC 343/702

(57) ABSTRACT

An electronic device including a first shell, a second shell, a connecting unit, an antenna unit and an isolating unit is provided. A material of the first shell includes a conductive material. A material of the second shell includes a conductive material. The connecting unit includes two connecting portions connected to the first shell and the second shell. The antenna unit includes a first antenna and a second antenna. The first antenna and the second antenna correspond to the two connecting portions respectively and are disposed on the first shell or the second shell. The isolating unit is disposed between the first antenna and the second antenna and includes at least one isolating conductor. The isolating conductor is connected to the first shell and extends toward the second shell, such that the first shell and the second shell form a conducting circuit through the isolating conductor.

### CROSS-REFERENCE TO RELATED APPLICATION

This application claims the priority benefits of U.S. provisional application Ser. No. 61/643,369, filed on May 7, 2012. The entirety of the above-mentioned patent application is hereby incorporated by reference herein and made a part of this specification.

### TECHNICAL FIELD

The invention relates to an electronic device, and particularly to an electronic device with an antenna.

### BACKGROUND

Due to the increasing demands to the quality, reliability, and speed of transmission of wireless communication signal, some multiple-antenna systems have been developed, such as the technological developments of the pattern switchable or beam-steering antenna system or the multi-input multi-output (MIMO) antenna system. For example, the current MIMO antenna technology (IEEE 802.11n) at the frequency band (2400-2484 MHz, 84 MHz) of the wireless local area network (WLAN) system has been successfully employed in products such as notebook computers, hand-held communication devices, or wireless access points. In the conventional design of notebook computers, a MIMO antenna system is configured at an upper part of the display screen, and the display screen is formed of a non-metallic material, such that the two antennas are kept in a distance to meet the need of high isolation and avoid the mutual interference between the two antennas having the same resonate frequency.

However, there are recently some notebook computers having a case formed of a metallic and conductive material at the base and cover of the notebook computers, and the MIMO antenna of the notebook computers are usually disposed at a position at which the base and cover are pivoted based on the design needs. Under such disposition, since the base and the cover are conductive and are capable of transmit signals, signals of the two antennas having the same resonate frequency interfere with each other through the base and the cover. Therefore, even if the distance between the two antennas is increased, the need of high isolation cannot be met.

### SUMMARY

The invention provides an electronic device that allows an antenna unit of the electronic device to meet the need of high isolation.

The invention provides an electronic device, including a first shell, a second shell, a connecting unit, an antenna unit, and an isolating unit. A material of the first shell includes a conductive material. A material of the second shell includes a conductive material. The connecting unit includes two connecting portions that are connected to the first shell and the second shell. The antenna unit includes a first antenna and a second antenna. The first antenna and the second antenna respectively correspond to the two connecting portions and are disposed on the first shell or the second shell. The isolating unit is disposed between the first antenna and the second antenna and includes at least one isolating conductor. The isolating conductor is connected to the first shell and extends toward the second shell, such that the first shell and the second shell form a conducting circuit through the isolating conductor.

In an embodiment of the invention, the electronic device includes a base and a cover that are mutually pivoted, wherein one of the first shell and the second shell is an upper cover of the cover or a lower cover of the cover, and the other of the first shell and the second shell is an upper shell of the base or a lower shell of the base.

In an embodiment of the invention, two ends of the isolating conductors are respectively connected to the first shell and the second shell.

In an embodiment of the invention, one end of the isolating conductor is connected to the first shell, another end of the isolating conductor keeps a distance from the second shell, and the isolating conductor and the second shell are equivalent to a capacitor.

In an embodiment of the invention, the isolating conductor is L-shaped.

In an embodiment of the invention, the first antenna and the second antenna have the same resonate frequency.

In an embodiment of the invention, a number of the at least one isolating conductor is more than one, and the isolating conductors are disposed separately.

Based on the above, the isolating conductors of the invention is disposed between the first antenna and the second antenna, and the first shell and second shell of the electronic device form a conducting circuit through the isolating conductor. Thereby, even if the first shell and the second shell are conductive and are capable of transmitting signals, signals of the first antenna and the second antenna do not interfere with each other due to isolation of the conducting circuit. In this way, the antenna unit meets the need of high isolation.

To make the aforementioned and other features and advantages of the invention more comprehensible, several embodiments accompanied with figures are described in detail below.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the invention.

FIG. 1 is a perspective view of an electronic device according to an embodiment of the invention.

FIG. 2 is an enlarged partial view of the electronic device of FIG. 1.

FIG. 3 is a perspective view of an electronic device according to an embodiment of the invention.

FIG. 4 is an enlarged partial view of the electronic device of FIG. 3.

FIG. 5 is a partial view of an electronic device according to another embodiment of the invention.

### DETAILED DESCRIPTION OF DISCLOSED EMBODIMENTS

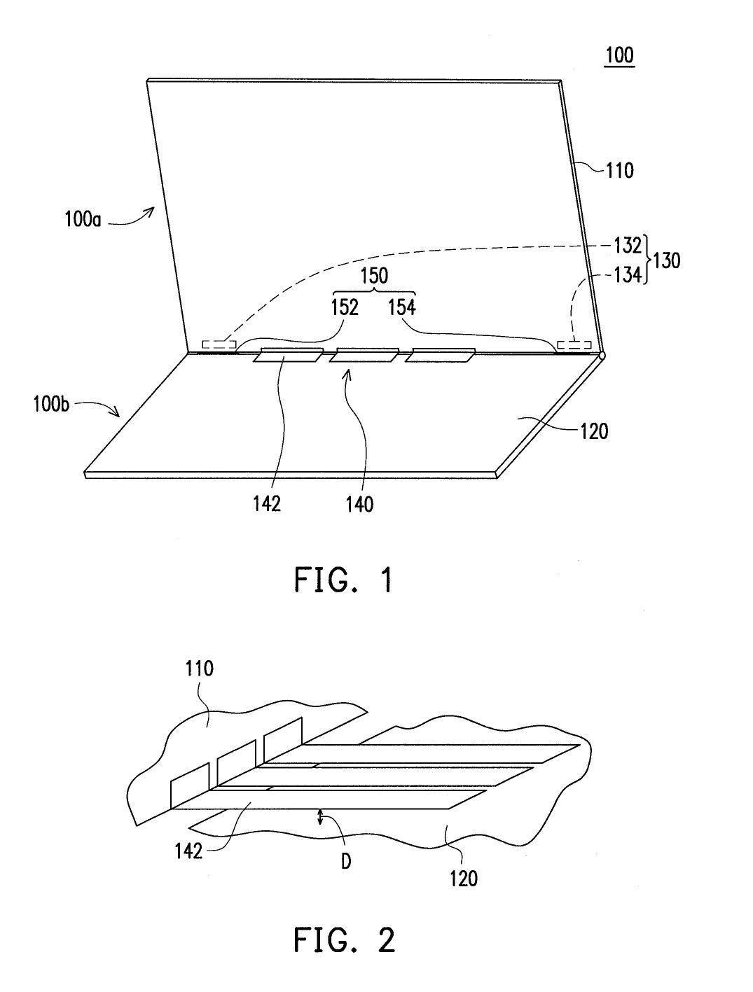

FIG. 1 is a perspective view of an electronic device according to an embodiment of the invention. Referring to FIG. 1, an electronic device 100 of this embodiment is, for example, a notebook computer, and includes a first shell 110, a second shell 120, an antenna unit 130, an isolating unit 140, and a connecting unit 150. The first shell 110 is, for example, an upper cover or a lower cover of a cover 100a of the electronic device 100, whereas the second shell 120 is, for example, an upper shell or a lower shell of a base 100b of the electronic device 100. The connecting unit 150 includes connecting portions 152 and 154. The connection portions 152 and 154 are connected to the first shell 110 and the second shell 120. The connection portions 152 and 154 are, for example, part of the pivot shaft of a notebook computer. A material of the first shell 110 includes a metallic material and is a conductive material, whereas a material of the second shell 120 includes a metallic material and is a conductive material.

The antenna unit 130 includes a first antenna 132 and a second antenna 134. The first antenna 132 and the second antenna 134 respectively correspond to the connecting portion 152 and the connecting portion 154, and are disposed on the first shell 110. In other embodiments, the first antenna 132 and the second antenna 134 may be disposed on the second shell 120 as well. There invention is not limited thereto. The first antenna 132 and the second antenna 134 have the same resonate frequency. The isolating unit 140 is disposed between the first antenna 132 and the second antenna 134 and includes at least one isolating conductor 142 (shown in a plural number).

FIG. 2 is an enlarged partial view of the electronic device of FIG. 1. Referring to FIGS. 1 and 2, each of the isolating conductors 142 is connected to the first shell 110 and extends toward the second shell 120, such that the first shell 110 and the second shell 120 form a conducting circuit between the first antenna 132 and the second antenna 134 through each of the isolating conductors 142. Thereby, even if the first shell 110 and the second shell 120 are conductive metallic shells and are capable of transmitting signals, signals of the first antenna 132 and the second antenna 134 having the same resonate frequency do not interfere with each other due to isolation of the conducting circuit. In this way, the antenna unit 130 meets the need of high isolation.

To make the drawings clearer, the isolating conductors 142 are illustrated as being exposed from the cover 100a and the base 100b and explicitly shown in FIGS. 1 and 2. Actually, the isolating conductors 142 may be designed as being hidden inside the cover 100a or the base 100b. The invention is not limited thereto.

Referring to FIG. 2, specifically speaking, one end of each of the isolating conductors 142 is connected to the first shell 110, whereas another end of each of the isolating conductors 142 keeps a distance D from the second shell 120, such that each of the isolating conductors 142 and the second shell 120 form an equivalent to a capacitor, and form an equivalent inductor when used with a current flowing through the first shell 110 and the second shell 120. Therefore, it may be considered as a filter from the high-frequency perspective. By adjusting a size of each of the isolating conductors 142 and a length of the distance D, the filter is suitable for blocking a signal in the resonance frequency band of the first antenna 132 and the second antenna 134 as well as improving a radiating efficiency of the first antenna 132 and the second antenna 134. Thereby, the interference between the first antenna 132 and the second antenna 134 is avoided and a transmission quality is improved. It should be noted that in this embodiment, although the isolating conductors 142 are not substantially connected, the capacitor between the isolating conductors 142 and the second shell 120 may be considered as a short circuit when it is in a high-frequency state. Therefore, the first shell 110 and the second shell 120 form a conducting circuit between the first antenna 132 and the second antenna 134 through each of the isolating conductors 142.

In this embodiment, a number of the isolating conductors 142 is, for example, three. In addition, the isolating conductors 142 are disposed separately with an appropriate interval. The number and interval of the isolating conductors 142 may be adjusted based on the needs, such that the isolating conductors 142 render a preferable effect of signal isolation. In addition, in this embodiment, each of the isolating conductors 142 is L-shaped, as illustrated in FIG. 2. Thereby, each of the isolating conductors 142 is allowed to be connected to the first shell 110 and extend toward the second shell 120. In other embodiments, each of the isolating conductors 142 may be appropriately arranged in a different shape. The invention is not limited thereto.

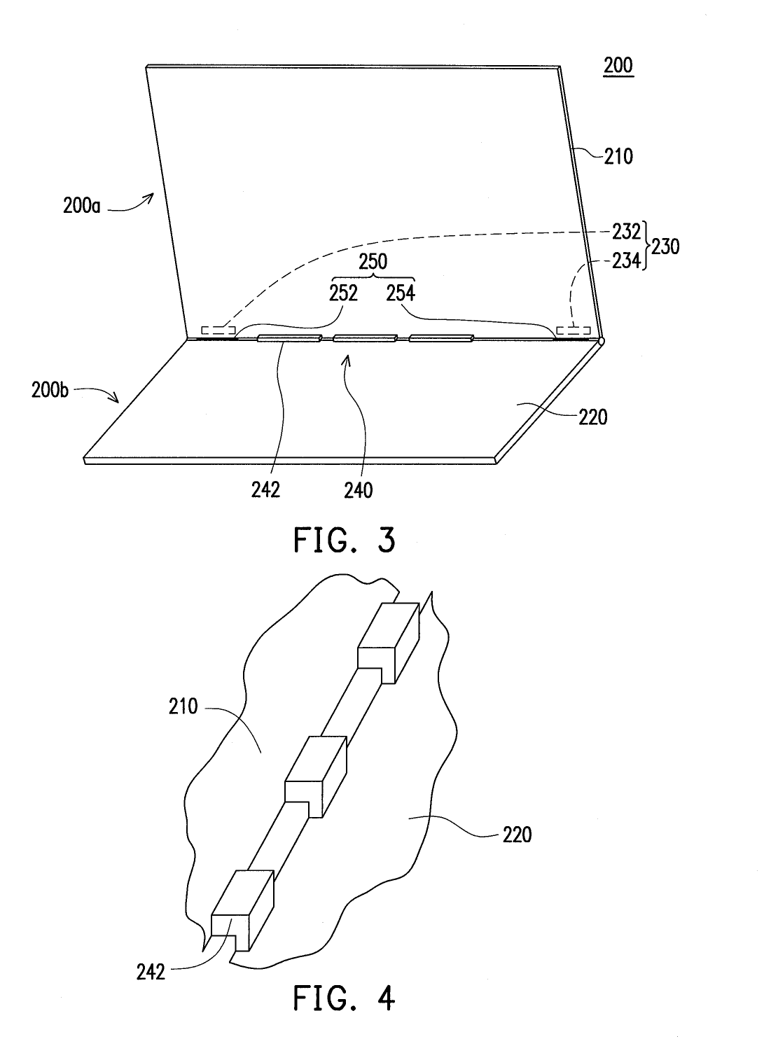

FIG. 3 is a perspective view of an electronic device according to an embodiment of the invention. Referring to FIG. 3, an electronic device 200 of this embodiment is, for example, a notebook computer, and includes a first shell 210, a second shell 220, an antenna unit 230, an isolating unit 240, and a connecting unit 250. The first shell 210 is, for example, an upper cover or a lower cover of a cover 200a of the electronic device 200, whereas the second shell 220 is, for example, an upper shell or a lower shell of a base 200b of the electronic device 200. The connecting unit 250 includes connecting portions 252 and 254. The connection portions 252 and 254 are connected to the first shell 210 and the second shell 220. The connection portions 252 and 254 are, for example, part of the pivot shaft of a notebook computer. A material of the first shell 210 includes a metallic material and is a conductive material, whereas a material of the second shell 220 includes a metallic material and is a conductive material.

The antenna unit 230 includes a first antenna 232 and a second antenna 234. The first antenna 232 and the second antenna 234 respectively correspond to the connecting portion 252 and the connecting portion 254, and are disposed on the first shell 210. In other embodiments, the first antenna 232 and the second antenna 234 may be disposed on the second shell 220 as well. There invention is not limited thereto. The antenna unit 230 includes a first antenna 232 and a second antenna 234. The first antenna 232 and the second antenna 234 have the same resonate frequency. The isolating unit 240 is disposed between the first antenna 232 and the second antenna 234 and includes at least one isolating conductor 242 (shown in a plural number).

FIG. 4 is an enlarged partial view of the electronic device of FIG. 3. Referring to FIGS. 3 and 4, each of the isolating conductors 242 is connected to the first shell 210 and extends toward the second shell 220, such that the first shell 210 and the second shell 220 form a conducting circuit between the first antenna 232 and the second antenna 234 through each of the isolating conductors 242. Thereby, even if the first shell 210 and the second shell 220 are conductive metallic shells and transmit a signal, signals of the first antenna 232 and the second antenna 234 having the same resonate frequency do not interfere with each other due to isolation of the conducting circuit. In this way, the antenna unit 230 meets the need of high isolation.

To make the drawings clearer, the isolating conductors 242 are illustrated as being exposed from the cover 200a and the base 200b and explicitly shown in FIGS. 3 and 4. Actually, the isolating conductors 242 may be designed as being hidden inside the cover 200a or the base 200b. The invention is not limited thereto.

Referring to FIG. 4, specifically speaking, the isolating unit 240 of this embodiment and the isolating unit 140 shown in FIGS. 1 and 2 differ in that two ends of each of the isolating conductors 242 are respectively connected to the first shell 210 and the second shell 220, such that the first shell 210 and the second shell 220 form a short circuit through a connection of each of the isolating conductors 242. Thereby, when a signal of the first antenna 232 is transmitted toward the second antenna 234 through the first shell 210 and the second shell 220, the signal returns to the first antenna 232 through the conducting circuit constituted of each of the isolating conductors 242, so as to avoid the interference of the signal of the first antenna 232 to the second antenna 234 as well as improving a radiating efficiency of the first antenna 232 and the second antenna 234. Similarly, when a signal of the second antenna 234 is transmitted toward the first antenna 232 through the first shell 210 and the second shell 220, the signal returns to the second antenna 234 through the conducting circuit constituted of each of the isolating conductors 242, so as to avoid the interference of the signal of the second antenna 234 to the first antenna 232 as well as improving the radiating efficiency of the first antenna 232 and the second antenna 234.

In this embodiment, a number of the isolating conductors 242 is, for example, three. In addition, the isolating conductors 242 are disposed separately with an appropriate interval. The number and interval of the isolating conductors 242 may be adjusted based on the needs, such that the isolating conductors 242 render a preferable effect of signal isolation. In addition, in this embodiment, each of the isolating conductors 242 is L-shaped, as illustrated in FIG. 4. Thereby, each of the isolating conductors 242 is allowed to be connected between the first shell 210 and the second shell 220. In other embodiments, each of the isolating conductors 242 may be appropriately arranged in a different shape. The invention is not limited thereto.

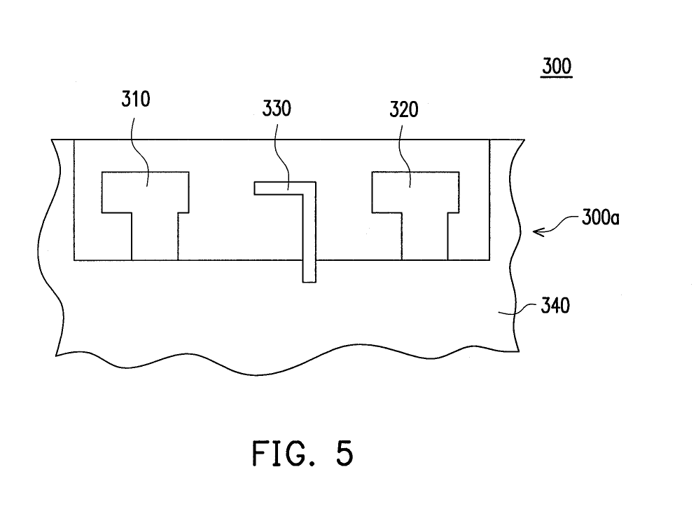

FIG. 5 is a partial view of an electronic device according to another embodiment of the invention. Referring to FIG. 5, an electronic device 300 of this embodiment is, for example, a notebook computer, and includes a housing 300a, a first antenna unit 310, a second antenna 320, and an isolating conductor 330. The housing 300a is, for example, a housing of a base of the electronic device 300. In addition, a material of a portion of the housing 300a, namely a case 340, includes a metallic material and is a conductive material. The first antenna 310 and the second antenna 320 are disposed on the housing 300a. The isolating conductor 330 is disposed on the housing 300a and located between the first antenna 310 and the second antenna 320.

The first antenna 310 and the second antenna 320, for example, have the same resonate frequency. In addition, the isolating conductor 330 has a specified length that meet the resonate frequency. When a signal of the first antenna 310 is transmitted toward the second antenna 320 through the case 340, the signal is transmitted to the isolating conductor 330 instead of being transmitted to the second antenna 320, thereby avoiding the interference of the signal of the first antenna 310 to the second antenna 320. Similarly, when a signal of the second antenna 320 is transmitted toward the first antenna 310 through the case 340, the signal is transmitted to the isolating conductor 330 instead of being transmitted to the first antenna 310, thereby avoiding the interference of the signal of the second antenna 320 to the first antenna 310. In this embodiment, the isolating conductor 340 may be in a L shape, a T shape, or other shapes that are appropriately bent, so as to have a sufficient length to meet the resonate frequency given a limited space for disposition.

Based on the above, the isolating conductor of the invention is disposed between the first antenna and the second antenna, and the case of the electronic device forms a conducting circuit through the isolating conductor. Thereby, even if the case of the electronic device is conductive and is capable of transmitting signals, signals of the first antenna and the second antenna do not interfere with each other due to isolation of the conducting circuit. In this way, the antenna unit meets the need of high isolation.

Although the invention has been described with reference to the above embodiments, it is apparent to one of the ordinary skill in the art that modifications to the described embodiments may be made without departing from the spirit of the invention. Accordingly, the scope of the invention will be defined by the attached claims not by the above detailed descriptions.

What is claimed is:

1. An electronic device, comprising:
a first shell, wherein a material of the first shell comprises a conductive material;
a second shell, wherein a material of the second shell comprises a conductive material;
a connecting unit, comprising two connecting portions that are connected to the first shell and the second shell;
an antenna unit, comprising a first antenna and a second antenna, wherein the first antenna and the second antenna respectively correspond to the two connecting portions and are disposed on the first shell or the second shell; and
an isolating unit, disposed between the first antenna and the second antenna and comprising at least one isolating conductor, wherein the isolating conductor is connected to the first shell and extends toward the second shell, such that the first shell and the second shell form a conducting circuit through the isolating conductor.

2. The electronic device as claimed in claim 1, comprising a base and a cover that are mutually pivoted, wherein one of the first shell and the second shell is an upper cover of the cover or a lower cover of the cover, and the other of the first shell and the second shell is an upper shell of the base or a lower shell of the base.

3. The electronic device as claimed in claim 1, wherein two ends of the isolating conductor are respectively connected to the first shell and the second shell.

4. The electronic device as claimed in claim 1, wherein one end of the isolating conductor is connected to the first shell, another end of the isolating conductor keeps a distance from the second shell, and the isolating conductor and the second shell can be equivalent to a capacitor.

5. The electronic device as claimed in claim 1, wherein the isolating conductor is L-shaped.

6. The electronic device as claimed in claim 1, wherein the first antenna and the second antenna have the same resonate frequency.

7. The electronic device as claimed in claim 1, wherein a number of the at least one isolating conductor is more than one, and the isolating conductors are disposed separately.
